(19) United States
(12) Patent Application Publication
(10) Pub. No.: US 2025/0115157 A1
(43) Pub. Date: Apr. 10, 2025

(54) SYSTEM FOR RECOMMENDING CHARGING STATION OF ELECTRIC VEHICLE APPLIED SPECIFIC DRIVING ROUTES

(71) Applicant: KKUN, Jeonbuk-do (KR)

(72) Inventor: BYEONGCHAN SIM, Jeonbuk-do (KR)

(21) Appl. No.: 18/882,972

(22) Filed: Sep. 12, 2024

(30) Foreign Application Priority Data
Oct. 4, 2023 (KR) 10-2023-0131834

(51) Int. Cl. B60L 58/12

(52) U.S. Cl. CPC B60L 58/12; B60L 2240/72; B60L 2260/52; B60L 2260/54

(57) ABSTRACT

A system is for recommending a charging station of an electric vehicle applied specific driving routes. The system includes a vehicle driving information collection unit, a database unit that includes a first vehicle driving information database, a second vehicle driving information database a charging station database, and a driving route database to generate first expected battery state information, and a charging station guide unit that determines whether the battery is required to be charged according to the first expected battery state information and analyzes a charging station with a shortest movement route in the charging station database and transmits the analyzed result to a user terminal.

### CROSS-REFERENCE TO RELATED APPLICATION AND CLAIM OF PRIORITY

This application claims the benefit under 35 USC § 119 of Korean Patent Application No. 10-2023-0131834, filed on Oct. 4, 2023, in the Korean Intellectual Property Office, the entire disclosure of which is incorporated herein by reference for all purposes.

### BACKGROUND

### 1. Field

The present disclosure relates to a system for recommending a charging station of an electric vehicle applied specific driving routes, and more particularly, to a system for predicting battery state information based on a plurality of pieces of vehicle driving information data measured in advance in various environments for points corresponding to the same point on a driving route, and recommending an electric vehicle charging station with a shortest movement route installed on a driving route according to the predicted battery state information.

### 2. Description of Related Art

Unlike internal combustion engine vehicles, electric vehicles do not use fossil fuels, but use electricity as a power source. The demand for the electric vehicles is rapidly increasing in line with global eco-friendly policies.

Unlike general vehicles, an electric vehicle controls an electric motor using a high-voltage, high-capacity battery to drive the motor by discharging the energy of the battery such as starting a vehicle, adding starting torque when starting the vehicle, assisting engine torque while driving, stopping an engine when a vehicle is stationary, and restarting after idle stop, and controls the electric motor by generating power when stopped, generating power while driving, etc., to charge energy in the battery.

In other words, an electric vehicle drives using electric energy charged in the battery. Since the amount of electric energy consumed while driving is greater than the amount of electric energy charged, the battery capacity may be completely depleted when driving beyond a certain distance. Therefore, an electric vehicle driver should charge a battery at an electric charging station charging the battery when the driver cannot reach his/her destination before the battery is discharged.

The electric vehicle is classified into a direct charging method and a battery replacement method according to their characteristics. The direct charging method is divided into slow charging and rapid charging. The slow charging method is inexpensive, but has the disadvantage of taking a long time to fully charge a battery, and the rapid charging method refers to a method of charging a battery in a short time with high power.

Therefore, in order to drive an electric vehicle smoothly and efficiently, the electric vehicle should be able to reach a charging station before the battery is discharged and be charged, and should be able to be charged to a shortest time, with no waiting time, even at the charging station.

In particular, in the past, to find out a usable time or distance of a battery installed in an electric vehicle provided by an electric vehicle manufacturer, a voltage or current of the battery itself was measured and the usable time or distance was calculated based on the measured voltage or current.

However, since this does not take into account factors that affect the battery usage such as the overall condition of the electric vehicle, such as a driver's driving pattern, or the external environment of the electric vehicle, such as weather and traffic conditions, the usable time or distance of the battery was provided inaccurately.

Therefore, there is a need for a system for recommending a charging station of an electric vehicle based on actual driving records that predicts a drivable distance of the electric vehicle based on actual driving data, calculates a movement route and drivable distance to a destination based on the predicted drivable distance to recommend a charging station of an electric vehicle so that an electric vehicle driver may safely arrive at the destination without discharging a battery.

### SUMMARY

The present disclosure provides a system for charging an electric vehicle applied specific driving routes capable of comparing battery state information measured at a specific point on a first driving route with battery state information measured in advance in various driving environments for a reference point corresponding to the specific point to predict the battery state information while driving on driving routes and recommend a charging station according to the predicted battery state information.

In addition, the present disclosure provides a system for recommending a charging station of an electric vehicle applied specific driving routes capable of comparing driving condition information, weather information, and traffic information measured at a specific point on a driving route changing according to a driving time with a plurality of pieces of driving condition information, a plurality of pieces of weather information, and a plurality of pieces of traffic information measured in advance for a reference point corresponding to the specific point, respectively, to extract one or more of the plurality of pieces of driving condition information, the plurality of pieces of weather information, and the plurality of pieces of traffic information measured in advance and predict accurate battery state information.

The present disclosure provides a system for recommending a charging station of an electric vehicle applied specific driving routes, which can change to another driving route based on a plurality of pieces of environmental information for another driving route included in a driving route database and expected battery state information according to the plurality of pieces of environmental information, when it is predicted that it is impossible to recommend a charging station on the driving route.

Other objects of the present disclosure will become clearer through embodiments described below.

According to an aspect of the present disclosure, a system for recommending a charging station of an electric vehicle applied specific driving routes includes a vehicle driving information collection unit that generates a first vehicle driving information database including first battery state information and first environmental information at a specific point on a first driving route, a database unit that includes a first vehicle driving information database, a second vehicle driving information database including a plurality of pieces of second environmental information measured in advance in various environments corresponding to a plurality of reference points on the first driving route and a plurality of pieces of second battery state information analyzed according to the plurality of pieces of second environmental information, a charging station database according to the first driving route, and a driving route database including the first driving route, a battery state information prediction unit that compares the second vehicle driving information at a reference point matching the specific point among the plurality of reference points with the first vehicle driving information at the specific point to generate first expected battery state information, and a charging station guide unit that determines whether the battery is required to be charged according to the first expected battery state information and analyzes a charging station with a shortest movement route in the charging station database and transmits the analyzed result to a user terminal.

The battery state information prediction unit may compare the first environmental information measured at the specific point with the plurality of pieces of second environmental information measured in various environments on the reference point matching the specific point to extract the second environmental information matching the first environmental information, and determine whether the first battery state information matches the second battery state information analyzed according to the second environmental information matching the first environmental information to correct the first battery state information according to the second battery state information.

The first environmental information may include first driving state information, first weather information, and first traffic information, and the plurality of pieces of second environmental information may include a plurality of pieces of second driving state information, a plurality of pieces of second weather information, and a plurality of pieces of second traffic information measured in advance in various environments according to the first driving route.

The battery state information prediction unit may compare the first driving state information, the first weather information, and the first traffic information measured at the specific point on the first driving route, respectively, with the plurality of pieces of second driving state information, the plurality of pieces of second weather information, and the plurality of pieces of second traffic information measured in advance at the reference point corresponding to the specific point to extract one or more of the plurality of pieces of second driving state information, the plurality of pieces of second weather information, and the plurality of pieces of second traffic information and evaluate the accuracy of the first battery state information.

An interval of the specific points on the first driving route changing according to a first driving time may be adjusted according to one or more of the first battery state information, the first driving state information, the first weather information, and the first traffic information.

When it is predicted that it is impossible to recommend the charging station on the first driving route, the charging station guide unit may change the first driving route to the second driving route based on the first battery state information, the first environmental information, a plurality of pieces of third environmental information according to the second driving route further included in the driving route database, and a plurality of pieces of third battery information according to the third environmental information.

### BRIEF DESCRIPTION OF THE DRAWINGS

FIG. 1 is a block diagram illustrating a configuration of a system for recommending a charging station of an electric vehicle applied specific driving routes according to an embodiment of the present disclosure.

FIG. 2 is a detailed block diagram illustrating a detailed configuration of the system for recommending a charging station of an electric vehicle applied specific driving routes according to an embodiment of the present disclosure in FIG. 1.

FIG. 3 is an exemplary diagram illustrating a method of analyzing battery state information of the system for recommending a charging station of an electric vehicle applied specific driving routes according to an embodiment of the present disclosure in FIG. 1.

FIG. 4 is a reference diagram illustrating a method of predicting battery state information of the system for recommending a charging station of an electric vehicle applied specific driving routes according to an embodiment of the present disclosure in FIG. 1.

FIG. 5 is a flowchart of the system for recommending a charging station of an electric vehicle applied specific driving routes according to an embodiment of the present disclosure in FIG. 1.

FIG. 6 is a flowchart of the system for recommending a charging station of an electric vehicle applied specific driving routes according to another embodiment of the present disclosure.

FIG. 7 is a reference diagram of a method of changing to another specific driving route of the system for recommending a charging station of an electric vehicle applied specific driving routes according to another embodiment of the present disclosure.

### DETAILED DESCRIPTION

The present disclosure may be variously modified and have several forms. Therefore, specific exemplary embodiments of the present disclosure will be illustrated in the accompanying drawings and be described in detail in the present specification. However, it is to be understood that the present disclosure is not limited to the specific exemplary embodiments, but includes all modifications, equivalents, and substitutions included in the spirit and the scope of the present disclosure. When it is determined that a detailed description of any known art related to the present disclosure may obscure the gist of the present disclosure, the detailed description will be omitted.

The terms used herein are used only in order to describe specific embodiments rather than limiting the present disclosure. Singular forms include plural forms unless the context clearly indicates otherwise. It is to be understood that the term “include” or “have” used here specifies the presence of features, numbers, steps, operations, components, parts, or combinations thereof mentioned in the present specification, or combinations thereof, but does not preclude the presence or addition of one or more other features, numbers, steps, operations, components, parts, or combinations thereof.

The terms such as ‘first’ and ‘second’ may be used to describe various components, but these components are not to be interpreted to be limited to these terms. The terms are used to distinguish one component from another component.

Hereinafter, embodiments of the present disclosure will be described in detail with reference to the accompanying drawings. In describing an exemplary embodiment of the present disclosure with reference to the accompanying drawings, components that are the same as or correspond to each other will be denoted by the same reference numerals regardless of the reference numbers, and an overlapped description thereof will be omitted.

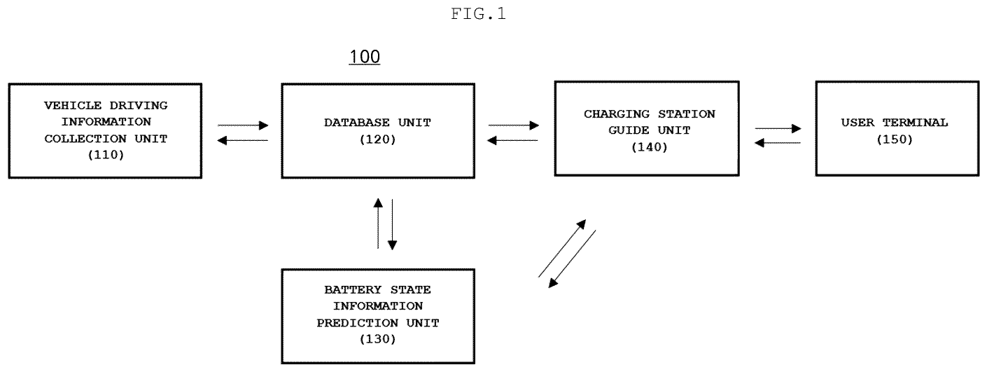

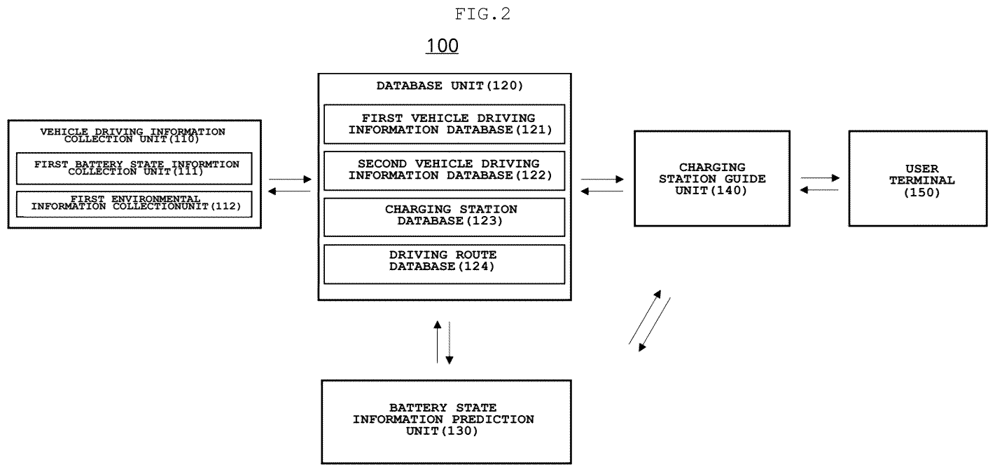

FIG. 1 is a block diagram illustrating a configuration of a system for recommending a charging station of an electric vehicle applied specific driving routes according to an embodiment of the present disclosure, and FIG. 2 is a detailed block diagram illustrating a detailed configuration of the system for recommending a charging station of an electric vehicle applied specific driving routes according to an embodiment of the present disclosure in FIG. 1.

Referring to FIGS. 1 and 2, a system 100 for charging an electric vehicle applied specific driving routes according to an embodiment of the present disclosure may include a vehicle driving information collection unit 110, a database unit 120, a battery state information prediction unit 130, a charging station guide unit 140, and a user terminal 150.

The vehicle driving information collection unit 110 may generate a first vehicle driving information database including first battery state information and first environmental information at a specific point on a first driving route.

Here, the first driving route may be one of various driving routes that drive to the same departure point and destination.

For example, the first driving route may be a driving route that satisfies an optimal charging time considering battery consumption for an electric vehicle that moves along a predetermined route.

Here, the electric vehicle may include a delivery vehicle, a shuttle bus, etc., that moves along a predetermined route every day and delivers logistics.

The vehicle driving information collection unit 110 may include a first battery state information collection unit 111 and a first environmental information collection unit 112.

Here, the first battery state information collected by the first battery state information collection unit 111 may include first battery state information measured at each specific point on the first driving route.

In detail, the first battery state information collection unit 111 may measure battery state information including various types of information related to the electric vehicle battery, such as the battery state of charge (SOC) of the electric vehicle, battery consumption per unit time, and a temperature of the battery itself, at each specific point on the driving route.

In addition, the first battery state information is data measured at each specific point on the driving route, and a first vehicle driving information database 121 may be generated by the first battery state information measured at each specific point.

Here, the first battery state information collection unit 111 may directly measure battery state information by an IoT sensor mounted on the electric vehicle, and thus, collect information reflecting internal/external environments of the electric vehicle.

The first environmental information collection unit 112 may collect first driving state information, first weather information, and first traffic information at each specific point on the driving route.

The first driving state information corresponds to various types of information that may affect a drivable distance of the electric vehicle, and can include a driving time, a traveling time, a driving speed, a sudden braking and sudden acceleration cycle, tire pressure, internal/external temperature and humidity of the electric vehicle, the number of passengers, a weight of loaded luggage, etc.

Specifically, the first environmental information collection unit 112 may include GPS, a temperature sensor, a humidity sensor, a weight sensor, a speed and acceleration sensor, a pressure sensor, etc., to collect the first driving state information.

That is, the battery state information can be predicted by comparing the first driving state information measured by the first environmental information collection unit 112 according to the embodiment of the present disclosure with a plurality of pieces of second driving state information included in a plurality of pieces of second environmental information of a second vehicle driving information database 122.

In addition, the first weather information is weather information at a current time, and information on the temperature, humidity, rainfall, snowfall, etc., of the first driving route may be collected at each specific point.

Specifically, the first weather information is weather information for the first driving route, and may be collected by being connected to a plurality of open application programming interfaces (APIs) provided by public institutions that provide weather information, such as the Korea Meteorological Administration.

Specifically, the first weather information may include general weather information, such as temperature, humidity, rainfall and snowfall, rainfall and snowfall probability, and sunrise time and sunset time, and disaster information, such as typhoon, flood, heavy rain, and heavy snow, of the first driving route.

That is, the first weather information measured by the first environmental information collection unit 111 may be compared with a plurality of pieces of second weather information included in the second environmental information of the second vehicle driving information database 122 to predict first expected battery state information.

In addition, the first traffic information is traffic information for a specific point on the first driving route, and may be collected by being connected to the plurality of open APIs provided by the plurality of public institutions for the specific point on the first driving route.

Specifically, the first traffic information may include traffic-related information for the first driving route, and include not only direct related information such as traffic light information, traffic conditions, accidents or gatherings, congestion, and construction, but also indirect related information related to traffic such as traffic safety facilities, road sign management systems, and allowable loads for tunnels and bridges.

That is, the first expected battery state information may be predicted by comparing the first traffic information measured by the first environmental information collection unit 112 according to the embodiment of the present disclosure with a plurality of pieces of second traffic information included in a plurality of pieces of second environmental information of the second vehicle driving information database 122.

As a result, the vehicle driving information collection unit 110 according to the embodiment of the present disclosure may collect the battery state information measured at each specific point while driving on the first driving route and environmental information including the driving state information, the weather information, and the traffic information for the electric vehicle driving environment to predict the battery state information of the electric vehicle.

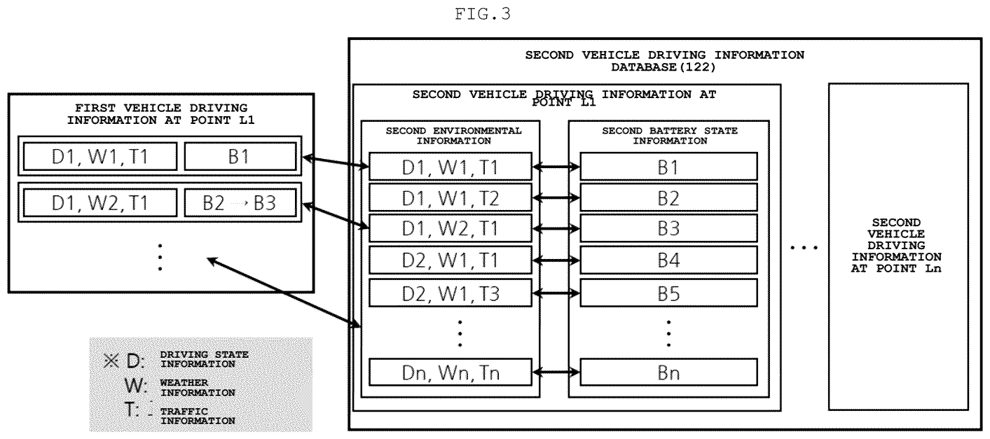

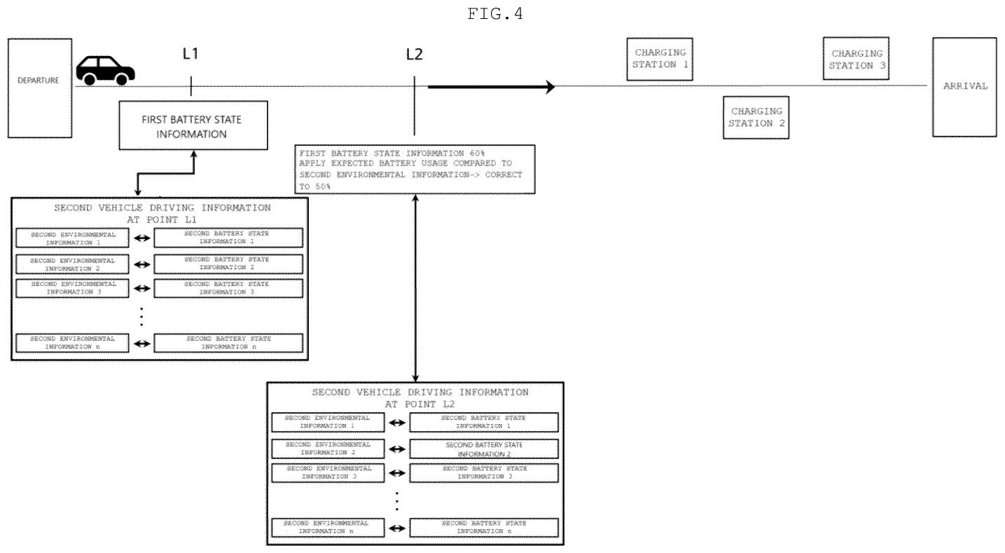

A method of collecting the first battery state information and the first environmental information and analyzing and predicting the battery state information using the collected first battery state information and first environmental information will be described in detail with reference to FIGS. 3 and 4.

Referring back to FIG. 2, the database unit 120 may include the first vehicle driving information database 121, the second vehicle driving information database 122, a charging station database 123, and a driving route database 124.

The first vehicle driving information database 121 may include first vehicle battery state information and first environmental information measured at each specific point while driving on the first driving route.

That is, the first vehicle driving information database 121 may store a plurality of pieces of data including the first battery state information of the electric vehicle driving on the first driving route and the internal/external environmental information data of the electric vehicle measured at each specific point.

Specifically, the first battery state information may be accumulated information on a plurality of first battery states collected at each specific point by the first battery state information collection unit 111 while driving on the first driving route.

In addition, the first environmental information may be a plurality of first driving state information, a plurality of pieces of first weather information, and a plurality of pieces of first traffic information collected at each specific point by the first environmental information collection unit 112 during driving of the first driving route.

The second vehicle driving information database 122 may include a plurality of pieces of second environmental information measured in advance in various environments at each of the plurality of reference points on the first driving route and a plurality of pieces of second battery state information analyzed according to the plurality of pieces of second environmental information.

Here, the plurality of pieces of second environmental information may include the internal/external environmental information of the driving electric vehicle measured in advance at each of the plurality of reference points on the first driving route.

Specifically, the plurality of pieces of second environmental information includes the plurality of pieces of second driving state information, the plurality of pieces of second weather information, and the plurality of pieces of second traffic information measured in advance in various environments at each of the plurality of reference points on the first driving route.

In addition, the plurality of reference points may be defined as reference points where the first driving route is divided into certain intervals.

Here, the plurality of pieces of second driving state information is second driving state information that is measured in advance according to various times, various weather, and traffic conditions for each of the plurality of reference points on the first driving route, and may include the driving time, the traveling time, the driving speed, the sudden braking and sudden acceleration cycle, the tire pressure, the internal/external temperature and humidity of the electric vehicle, the number of passengers, the weight of loaded luggage, and the user charging habits, etc., that are measured in advance in various driving environments.

In addition, the plurality of pieces of second weather information is weather information that is measured in advance while driving on the first driving route, and may include general weather information, such as temperature, humidity, rainfall and snowfall, rainfall and snowfall probability, sunrise time and sunset time, and disaster information, such as typhoon, flood, heavy rain, and heavy snow, etc., which are collected for each of the plurality of reference points on the first driving route.

In addition, the plurality of pieces of second traffic information is traffic information measured in advance while driving on the first driving route, and may include not only direct related information such as traffic light information, traffic conditions, accident or assembly, congestion, and construction collected at each of the plurality of reference points on the first driving route, but also indirect related information related to traffic such as traffic safety facilities, road sign management systems, and allowable loads of tunnels and bridges. For example, the plurality of pieces of second environmental information may be environmental information that changes at each of the plurality of reference points by dividing the first driving route into the plurality of reference points, and may include environmental information during rush hour on weekdays, environmental information during the early morning hours of the first driving route, environmental information during the daytime hours of holidays of the first driving route, etc.

In addition, the plurality of pieces of second battery state information analyzed according to the plurality of pieces of second environmental information may be various types of battery state information measured according to the plurality of pieces of second environmental information at the plurality of reference points of the first driving route in various environments.

Specifically, the plurality of pieces of second battery state information may be analyzed by reflecting information on a battery charge amount according to the number of times of charging, air conditioner operation time, a continuous driving time, a driving speed, the number of times of sudden accelerations and sudden stops, etc.

In particular, the battery performance may deteriorate when electric vehicles are exposed to high or low temperature environments, when the battery is completely discharged, and when the sudden acceleration and sudden stop occur.

In addition, electric vehicles consume battery power during the acceleration, but charge the battery during the deceleration. The electric vehicles may have a regenerative braking function when the first driving route includes a downhill slope or when driving in urban areas with frequent acceleration and deceleration, and therefore, reflect the regenerative braking function in the plurality of pieces of second vehicle battery state information.

For example, when the time of collecting the second driving state information is a summer morning, the second battery state information may vary depending on the user's air conditioner operation habit and the difference in temperature and humidity inside and outside the electric vehicle, the number of passengers, and the weight of luggage.

In addition, the recommended charging station route may vary depending on the user's charging habit, such as when the user does not charge the battery until the battery SOC is 20% or less or when the user frequently charges the battery.

That is, the plurality of pieces of second battery state information may include the battery consumption information that reflects the internal/external environments of the electric vehicle at each of the plurality of reference points on the first driving route.

As a result, according to an embodiment of the present disclosure, by making the plurality of pieces of battery state information analyzed according to various types of driving environmental information for the first driving route into a database, the battery state information according to the current driving environment may be accurately predicted.

The charging station database 123 may include information on charging stations installed on the first driving route.

Here, the charging station information may be information on chargers installed at locations accessible while driving on the first driving route.

Specifically, the charger information may include information on the total number of chargers in the charging station, the types of chargers, the number of currently available chargers, charging unit price information, charger usage congestion according to various driving times, etc.

Here, the charging station location information and the charger information may be compared with the charging station information acquired through the open API database and actual driving to secure the reliability of the charging station information.

In addition, the charging station database 123 may further include charging station information on a plurality of driving routes driving from a departure point to a destination.

That is, the system for recommending a charging station of an electric vehicle applied specific driving routes according to an embodiment of the present disclosure may provide an alternative driving route when charging is not possible at the charging station on the first driving route by using the charging station information on the plurality of driving routes stored in the charging station database 123.

The driving route database 124 may include first driving route data.

Specifically, the driving route database 124 may include a plurality of driving routes that may reach the same destination from the same departure point.

That is, the system for recommending a charging station of an electric vehicle applied specific driving routes according to an embodiment of the present disclosure may provide an alternative driving route when charging is not possible at the charging station on the first driving route by using the charging station information on the plurality of driving routes stored in the driving route database 124.

The battery state information prediction unit 130 may compare the first vehicle driving information with the second vehicle driving information to analyze the first expected battery state information among the plurality of pieces of battery state information.

In detail, the battery state information prediction unit 130 may extract the first environmental information measured at a specific point on the first driving route and the reference point on the first driving route matching the first specific point among the plurality of reference points to compare the first vehicle driving information with the second vehicle driving information. FIG. 3 is an exemplary diagram illustrating a method of analyzing battery state information of the system for recommending a charging station of an electric vehicle applied specific driving routes according to an embodiment of the present disclosure in FIG. 1.

Referring to FIG. 3, the battery state information prediction unit 130 may compare the plurality of pieces of second environmental information of the reference point L1 matching a specific point L1 on the first driving route among the plurality of pieces of reference points on the first driving route stored in the second vehicle driving information database 122 with the first environmental information of the first vehicle driving information.

In addition, the battery state information prediction unit 130 may extract the second environmental information matching the first environmental information of the first vehicle driving information among the plurality of pieces of second environmental information of the reference point L1 matching the specific point L1.

In addition, it is possible to determine whether the second battery state information analyzed according to the extracted second environmental information matches the first battery state information measured at the specific point L1.

Specifically, the battery state information prediction unit 130 may compare the first driving state information, the first weather information, and first traffic information, respectively, collected at the specific point on the first driving route by the first environmental information collection unit 112 of the vehicle driving information collection unit 110 with the plurality of pieces of second environmental information collected at the reference point corresponding to the specific point among the plurality of pieces of second environmental information for the plurality of reference points on the first driving route stored in the second vehicle driving information database 122 to extract the second environmental information matching the first environmental information.

In addition, the battery state information prediction unit 130 may extract one or more of the plurality of pieces of second driving state information, the plurality of pieces of second weather information, and the plurality of pieces of second traffic information to evaluate the accuracy of the first battery state information.

For example, when the first driving state information, the first weather information, and the first traffic information measured at the specific point are D1, W1, and T1, respectively, the battery state information prediction unit 130 may extract, from the second vehicle driving information database, the second environmental information where the second driving state information, the second weather information, the second traffic information of the reference point corresponding to the specific point, and the second environmental information are D1, W1, and T1.

In addition, the battery state information prediction unit 130 may compare the second battery state information analyzed according to the extracted second environmental information with the first battery state information.

Specifically, the battery state information prediction unit 130 may generate the first expected battery state information for the first driving route using the first battery state information when the second battery state information B1 according to the extracted second environmental information D1, W1, and T1 matches the first battery state information B1.

In addition, when second battery state information B3 according to second environmental information D1, W2, and T1 matching first environmental information D1, W2, and T1 is different from the first battery state information B1, the battery state information prediction unit 130 may generate the first expected battery state information for the first driving route by correcting the first battery state information to match the second battery state information.

In addition, when there is no second environmental information matching all of the first environmental information of the specific point among the plurality of pieces of second environmental information of the reference point corresponding to the specific point, the battery state information prediction unit 130 may extract the plurality of pieces of second battery state information corresponding to the second driving state information, the second weather information, and the second traffic information that match the first driving state information, the first weather information, and the first traffic information, respectively.

Specifically, when the plurality of pieces of second battery state information according to the second environmental information matching each of the first environmental information are extracted, the battery state information prediction unit 130 may evaluate the first battery state information by assigning a weight to the first environmental information or by using an average value of the first battery state information.

For example, if the second battery state information according to the second driving state information that matches the first driving state information, the second battery state information according to the second weather information that matches the first weather information, and the second battery state information according to the second traffic information that matches the first traffic information are different from each other, the second battery state information may be extracted by assigning weights to the driving state information, the weather information, and the traffic information, and reflected in the first battery state information to generate the first expected battery state information.

In addition, the battery state information prediction unit 130 may reflect the average value of the second battery state information according to the second driving state information matching the first driving state information, the second battery state information according to the second weather information matching the first weather information, and the second battery state information according to the second traffic information matching the first traffic information in the first battery state information to generate the first expected battery state information.

As a result, the battery state information prediction unit 130 according to the embodiment of the present disclosure may accurately evaluate the first battery state information by using the plurality of pieces of second environmental information measured in advance in various environments corresponding to the plurality of reference points on the first driving route and the plurality of pieces of second battery state information analyzed according to the plurality of pieces of second environmental information, and generate the first expected battery state information by using the accurately evaluated first battery state information.

FIG. 4 is a reference diagram illustrating a method of predicting battery state information of the system for recommending a charging station of an electric vehicle applied specific driving routes according to an embodiment of the present disclosure in FIG. 1.

Referring to FIG. 4, the first environmental information and the first battery state information measured at the specific point on the first driving route and the plurality of pieces of second environmental information and the plurality of pieces of second battery state information analyzed according to the plurality of pieces of second environmental information and the plurality of pieces of second environmental information measured in advance in various environments corresponding to the plurality of reference points on the first driving route may be compared to generate the first expected battery state information and guide the charging station.

Here, the vehicle driving information collection unit 110 may collect the first environmental information and the first battery state information at the specific point L1 on the first driving route.

In addition, the battery state information prediction unit 130 may extract the location information of the reference point L1 corresponding to the specific point L1 on the first driving route from the second vehicle driving information database 122 to determine the accuracy of the collected first environmental information and first battery state information.

In addition, the battery state information prediction unit 130 may compare the first vehicle driving information at the specific point L1 with the second vehicle driving information at the reference point corresponding to the specific point L1 to generate one or more pieces of first expected battery state information among the plurality of pieces of second battery state information.

Specifically, the battery state information prediction unit 130 may compare the first driving state information, the first weather information, and the first traffic information included in the first environmental information at the specific point L1 with the plurality of pieces of second driving state information, the plurality of pieces of second weather information, and the plurality of pieces of second traffic information included in the plurality of pieces of second environmental information at the reference point corresponding to the specific point L1 extracted from the second vehicle driving information database 122, respectively.

Here, the battery state information prediction unit 130 may extract the second environmental information matching the first environmental information among the plurality of pieces of second environmental information, and compare the second battery state information analyzed according to the second environmental information with the first battery state information collected by the vehicle driving information collection unit 110 at the specific point L1.

For example, when the first battery state information is 70% identical to the second battery state information, the battery state information prediction unit 130 may generate the first expected battery state information using the first battery state information.

In addition, the charging station guide unit 140 may analyze the first expected battery state information to determine whether the battery is required to be charged, and guide a charging station route of one of charging stations 1 to 3 by reflecting the charging time among the charging stations 1 to 3.

Here, the vehicle driving information collection unit 110 may collect the first environmental information and the first battery state information at another specific point L2 while driving on the charging station route of the first driving route according to the guidance of the charging station guide unit 140.

In addition, the battery state information prediction unit 130 may compare the first vehicle driving information at another specific point L2 with the second vehicle driving information at the reference point corresponding to the specific point L2 to generate one or more pieces of first expected battery state information among the plurality of pieces of second battery state information.

Specifically, the battery state information prediction unit 130 may compare the first driving state information, the first weather information, and the first traffic information included in the first environmental information at another specific point L2 with the plurality of pieces of second driving state information, the plurality of pieces of second weather information, and the plurality of pieces of second traffic information included in the plurality of pieces of second environmental information at the reference point corresponding to another specific point L2 extracted from the second vehicle driving information database 122, respectively.

Here, the battery state information prediction unit 130 may extract the second environmental information matching the first environmental information among the plurality of pieces of second environmental information, and compare the second battery state information analyzed according to the second environmental information with the first battery state information collected by the vehicle driving information collection unit 110 at another specific point L2.

For example, when the first battery state information is measured as 60%, but the second battery state information at the point L2 is measured as 50%, and thus, they are different from each other, the battery state information prediction unit 130 may correct the first battery state information to 50% using the second battery state information to generate the first expected battery state information.

In addition, the charging station guide unit 140 may analyze the first expected battery state information to determine whether the battery is required to be charged and modify the previously guided charging station route to guide the charging station route.

The second battery state information may be reflected in the first battery state information, and the expected battery state information may be analyzed using the reflected information to change and guide a charging station with the shortest movement route.

As a result, the battery state information prediction unit 130 according to the embodiment of the present disclosure may compare the first environmental information and the first battery state information measured at each specific point on the first driving route with the plurality of pieces of second environmental information and the plurality of pieces of second battery state information according to the second environmental information to analyze the first expected battery state information, and reflect the analyzed first expected battery state information in the charging station guide unit 140 that guides the charging station route with the shortest movement route.

In addition, the vehicle driving information collection unit 110 may measure the first environmental information and the first battery state information at the specific point on the first driving route.

Here, the specific point is measured at each certain interval on the first driving route, not at a fixed location, and may be a plurality of points, not just one specific point.

In addition, an interval of the specific points on the first driving route may be adjusted according to one or more of the first battery state information, the first driving state information, the first weather information, and the first traffic information.

For example, when the first battery state information measured through the first battery state information is 50% or more, the interval of the specific points on the first driving route where the first battery state information and the first environmental information are collected may be adjusted wide, and when the first battery SOC measured through the first battery state information is 50% or less, the interval of the specific points on the first driving route where the first battery state information and the first environmental information are collected may be adjusted short.

In addition, when the driving time of the first driving route is a commuting time, the first traffic information is likely to change rapidly, and the range of change in the first battery state information may vary accordingly, so the vehicle driving information collection unit 110 may collect the first environmental information and the first battery state information by adjusting the interval of the specific points on the first driving route to be short.

In the vehicle driving information collection unit 110 according to the embodiment of the present disclosure, by differentiating the interval of the specific points on the first driving route where the first battery state information and the first environmental information are collected according to the battery state, the battery consumption may be reduced when the first battery SOC is high, and the battery consumption may be measured in detail when the battery SOC is low, thereby preventing the battery from being discharged.

In addition, the charging station guide unit 140 may determine whether the battery is required to be charged according to the first expected battery state information, analyze the charging station with the shortest movement route in the charging station database 123, and transmit the analyzed result to the user terminal 150.

Specifically, it may be determined whether the battery is required to be charged by the first expected battery state analysis result by comparing the first vehicle driving information driving the first driving route in a specific environment with the plurality of pieces of second vehicle driving information.

For example, when the first environmental information and the first battery state information collected at the specific point L1 on the first driving route are 80%, and the second battery state information analyzed according to the second environmental information matching the first environmental information among the plurality of pieces of second environmental information of the reference point corresponding to the specific point L1 is 80%, and thus, they are identical to each other, the charging station guide unit 140 may guide the route to the charging station 2.

In addition, when the first environmental information and the first battery state information collected at another specific point L2 on the first driving route are 60%, and the second battery state information analyzed according to the second environmental information matching the first environmental information among the plurality of pieces of second environmental information of the reference point corresponding to another specific point L2 is 50%, and thus, they do not match each other, the battery state information prediction unit 130 may correct the first battery state information to 50% which is the second battery state information, so the time required for charging may be faster than the time measured at the specific point L1. In this case, the charging station guide unit 140 may guide the charging station route by changing the charging station route from charging station 2 to the charging station 1.

On the other hand, when the first environmental information and the first battery state information collected at another specific point L2 on the first driving route are 60%, and the second battery state information analyzed according to the second environmental information matching the first environmental information among the plurality of pieces of second environmental information of the reference point corresponding to another specific point L2 is 70%, and thus, they do not match each other, the battery state information prediction unit 130 may correct the first battery state information to 70% which is the second battery state information, so the time required for charging may be slower than the time measured at the specific point L1. In this case, the charging station guide unit 140 may guide the charging station route by changing the charging station route from charging station 2 to the charging station 3.

In addition, the charging station guide unit 140 may guide the charging station by reflecting the user's charging habit.

For example, when the battery SOC is expected to be 50% when reaching the charging station 2 on the first driving route, it is possible to guide the recommended route that passes through the charging station 1 or the charging station 3 by reflecting the user's charging habits.

In addition, when the user has a charging habit of maintaining the battery SOC at 50% or more, the charging station guide unit 140 may guide the route to the charging station 1.

On the other hand, when the user has a habit of charging when the battery SOC is less than 20%, the charging station guide unit 140 may guide the route to the charging station 3.

That is, the system for recommending a charging station of an electric vehicle applied specific driving routes according to the present embodiment may recommend the charging station of the electric vehicle applied the specific driving route customized to the user by reflecting both battery state information according to the environmental information measured in advance in various environments, the user's driving habits, etc.

The user terminal 150 may display the charging station recommended route with the shortest movement route analyzed by the charging station guide unit 140 to the user.

Here, the user terminal 150 may include navigation and/or a smartphone, etc., equipped in a vehicle that has a screen capable of displaying the charging station route to the user.

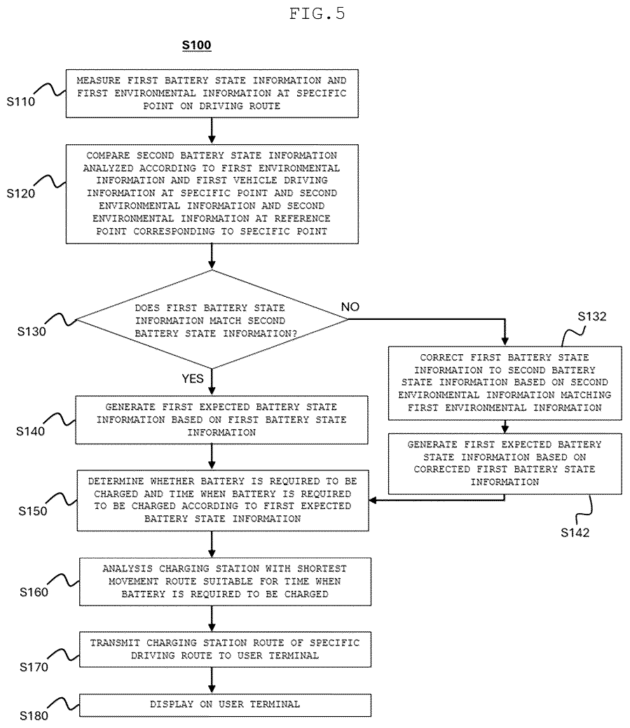

FIG. 5 is a flowchart of the system for recommending a charging station of an electric vehicle applied specific driving routes according to an embodiment of the present disclosure in FIG. 1.

Referring to FIG. 5, the vehicle driving information collection unit 110 may measure the first battery state information and the first environmental information of the electric vehicle at the specific point on the first driving route to generate the first vehicle driving information data (S110).

Here, the first battery state information and the first environmental information may be measured at each specific point and stored in the first vehicle driving information database 121.

In addition, the first battery state information may include various types of information related to the electric vehicle battery measured at a specific point, and the first environmental information may include the first driving state information, the first weather information, and the first traffic information measured at a specific point.

Here, the first battery state information and the first environmental information stored in the first vehicle driving information database 121 may be used for regression analysis and weight value analysis to refine the second vehicle driving information database.

In addition, the battery state information prediction unit 130 may compare the first environmental information collected at the specific point on the first driving route collected by the vehicle driving information collection unit 110 with the plurality of pieces of second environmental information of the reference point corresponding to the specific point stored in the second vehicle driving information database 122 and the plurality of pieces of second battery state information analyzed according to the plurality of pieces of second environmental information (S120).

Specifically, the battery state information prediction unit 130 may compare the first driving state information, the first weather information, and the first traffic information measured at the specific point on the first driving route with the plurality of pieces of second driving state information, the plurality of pieces of second weather information, and the plurality of pieces of second traffic information of the reference point corresponding to the location information of the specific point on the first driving route stored in the second vehicle driving information database 122, respectively.

It can be confirmed whether the second battery state information analyzed according to the second driving state information, the second weather information, and the second traffic information that match the first driving state information, the first weather information, and the first traffic information matches the first battery state information (S130).

When the second battery state information analyzed according to the second environmental information that matches the first environmental information matches the first battery state information, the battery state information prediction unit 130 may generate the first expected battery state information based on the first battery state information (S140).

On the other hand, when the second battery state information analyzed according to the second environmental information that matches the first environmental information does not match the first battery state information, the battery state information prediction unit 130 may correct the first battery state information to the second battery state information analyzed according to the second environmental information that matches the first environmental information (S132).

The battery state information prediction unit 130 may generate the first expected battery state information based on the corrected first battery state information (S142).

Here, the first expected battery state information may be defined as the expected battery consumption when driving to the destination using the second battery state information analyzed according to the second environmental information stored in the second vehicle driving information database 120.

That is, the first expected battery state information may be generated by calculating the battery consumption when driving on the first driving route at the specific point based on the second battery state information measured at the plurality of reference points on the first driving route measured in advance in various environments and reflecting the calculated battery consumption in the first battery state information.

In addition, the charging station guide unit 140 may determine whether the battery is required to be charged and the time when the battery is required to be charged while driving the first driving route according to the first expected battery state information (S150).

That is, the charging station guide unit 140 may confirm whether the battery is required to be charged while driving on the first driving route based on the first expected battery state information that predicts the battery SOC after moving to a certain distance.

In addition, when it is determined that the battery is required to be charged while driving on the first driving route, the charging station guide unit 140 may analyze the charging station route with the shortest movement route suitable for the time when the battery is required to be charged according to the first expected battery state information (S160).

In addition, the charging station guide unit 140 may transmit the charging station route reflecting the expected charging required time to the user terminal (S170).

For example, when there are charging stations with different movement distances on the first driving route, the charging station route may be analyzed according to the expected charging required time and transmitted to the user terminal.

The user terminal 150 may display the charging station route of the transmitted specific driving route (S180).

The system for recommending a charging station of an electric vehicle applied specific driving routes according to the embodiment of the present disclosure may compare the battery state information measured at each specific point of the first driving route with the battery state information measured in advance in various driving environments to output single battery state information, thereby improving the accuracy of the expected battery state information.

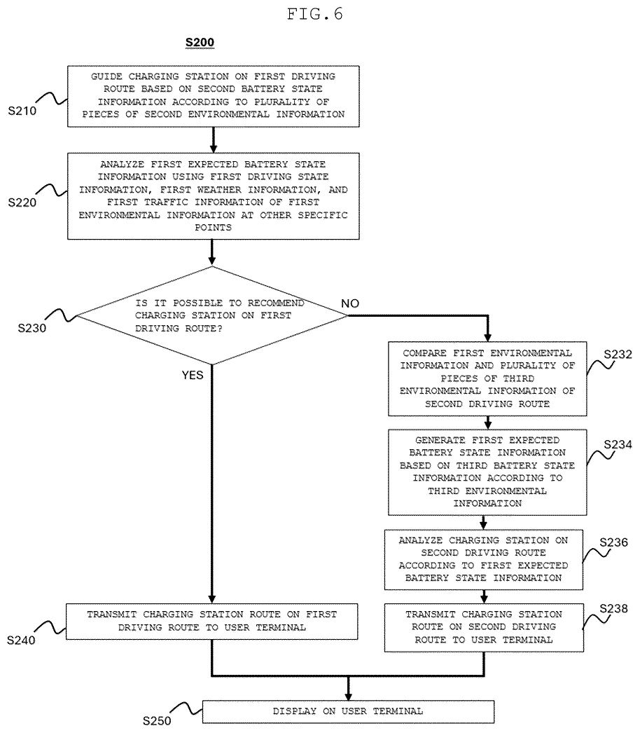

FIG. 6 is a flowchart of the system for recommending a charging station of an electric vehicle applied specific driving routes according to another embodiment of the present disclosure.

A system for recommending a charging station of an electric vehicle applied specific driving routes according to another embodiment of the present disclosure may guide a charging station on a first driving route based on second battery state information according to a plurality of pieces of second environmental information (S210).

In the system 100 for recommending a charging station of an electric vehicle applied specific driving routes, a method of guiding a charging station on a first driving route based on second battery state information analyzed according to a plurality of pieces of second environmental information is the same as a method of recommending a charging station of an electric vehicle applied specific driving route of FIGS. 1 to 5, and therefore, a detailed description thereof will be omitted.

The vehicle driving information collection unit 110 of the system 100 for recommending a charging station of an electric vehicle applied specific driving routes may collect first environmental information including first driving state information, first weather information, and first traffic information and first battery state information from another specific point located at a certain distance from a specific point.

In addition, the expected battery state information analysis unit 130 may generate first expected battery state information by using the first environmental information including the first driving state information, the first weather information, and the first traffic information collected at another specific point and the first battery state information, and the charging station guide unit 140 may generate a charging station route (S220).

In this case, when analyzing the expected battery according to the first driving state information, the first weather information, and the first traffic information at another specific point, it may be determined whether a charging station route recommendation on the first driving route recommended at the specific point is possible (S230).

When the same charging station recommendation as the charging station route recommended at the specific point is possible, the same charging station route of the first driving route may be transmitted to the user terminal 150 (S240).

The charging station route of the specific driving route transmitted to the user terminal 150 may be displayed (S250).

In this case, when analyzing the first driving state information, the first weather information, and the first traffic information at another specific point, there may be a case where it is impossible to recommend the same charging station route on the first driving route recommended at the specific point (S230).

For example, according to the first weather information collected at another specific point, it may be expected that heavy rain is expected on the first driving route and thus entry into the first driving route is impossible. In addition, according to the first traffic information collected at another specific point, it may be expected that the entry into the first driving route is impossible due to road construction.

In this case, the first driving route may be changed to the second driving route based on the first battery state information and the first environmental information, the plurality of pieces of third environmental information according to the second driving route further included in the driving route database, and the plurality of pieces of third battery information according to the third environmental information.

Specifically, the first environmental information and the plurality of pieces of third environmental information of the second vehicle driving information database 122 of the second driving route of the driving route database 124 may be compared (S232).

When the third environmental information of the second driving route that matches the first environmental information is analyzed, the first expected battery state information may be generated based on the third battery state information analyzed according to the third environmental information (S234).

In detail, when the first battery state information measured at another specific point matches the third battery state information, the first expected battery state information may be analyzed based on the first battery state information.

In addition, when the first battery state information measured at another specific point does not match the third battery state information, the first battery state information may be corrected to the third battery state information to generate the first expected battery state information.

In addition, the charging station guide unit 140 may analyze the charging station on the second driving route based on the first expected battery state information analyzed by the expected battery state information analysis unit 130 (S236).

In detail, the charging station guide unit 140 may determine whether the battery is required to be charged and the time when the battery is required to be charged while driving on another specific driving route based on the first expected battery state information.

That is, the charging station guide unit 140 may confirm whether the battery is required to be charged while driving on another specific driving route by predicting the battery SOC after moving to a certain distance.

In addition, if it is determined that the battery is required to be charged while driving on the second driving route, the charging station route of the shortest movement route suitable for the time when the charging is required may be analyzed according to the first expected battery state information.

Therefore, the charging station guide unit 140 may transmit the charging station route on the second driving route reflecting the expected charging required time to the user terminal (S238).

For example, when there are charging stations with different movement distances on the plurality of second driving routes, the charging station route may be analyzed according to the expected charging required time and transmitted to the user terminal.

The charging station route of the second driving route transmitted to the user terminal 150 may be displayed (S250).

That is, according to the system for recommending a charging station of an electric vehicle applied specific driving routes according to another embodiment of the present disclosure, when continuous driving on a specific route is impossible, a new route may be re-searched, expected battery state information for the new route may be analyzed, and a new charging station route may be guided.

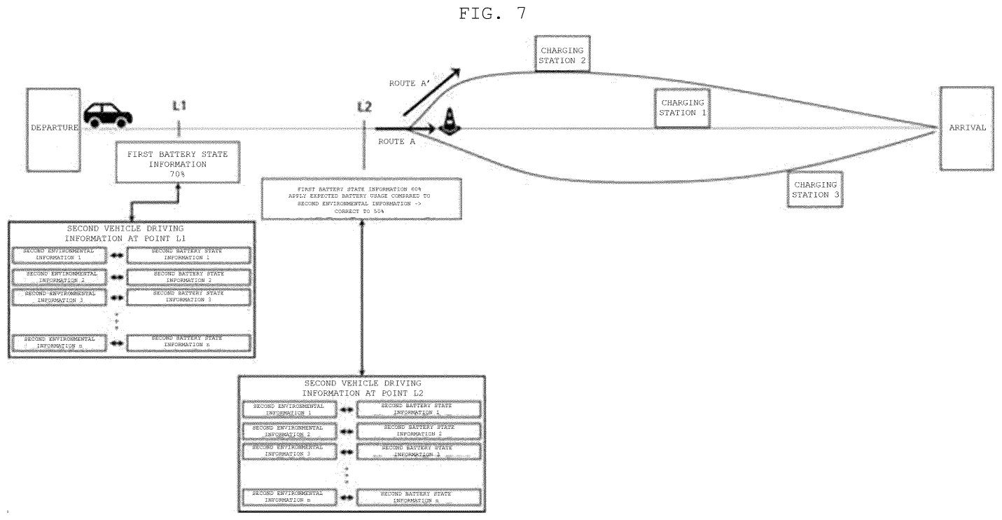

FIG. 7 is a reference diagram of a method of changing to another specific driving route of the system for recommending a charging station of an electric vehicle applied specific driving routes according to another embodiment of the present disclosure.

Referring to FIG. 7, the system 100 for recommending a charging station of an electric vehicle applied specific driving routes may guide a route to drive to charging station 1 of route A according to the first environmental information and first battery state information measured at the specific point L1 on the first driving route by the vehicle driving information collection unit 110.

Thereafter, according to first traffic information among the first environmental information collected at another specific point L2, construction is expected on route A, so the driving to the charging station 1 of the route A may be impossible.

In this case, the system 100 for recommending a charging station of an electric vehicle applied specific driving routes may search for a new route, route A′, which is the second driving route stored in the driving route database 124.

In addition, the system 100 for recommending a charging station of an electric vehicle applied specific driving routes may compare the plurality of pieces of second environmental information for the second route A′ stored in the second vehicle driving information database and the plurality of pieces of second battery state information analyzed according to the plurality of pieces of second environmental information with the first environmental information and the first battery state information again.

In this case, the expected battery state information analysis unit 130 may compare the second battery state information analyzed according to the second environmental information matching the first environmental information with the first battery state information to generate the first expected battery state information.

The charging station guide unit 140 may determine whether the battery is required to be charged and the time when the battery is required to be charged according to the driving on the second driving route A′ based on the generated first expected battery state information, and analyze the charging station with the shortest movement route according to the determined need of charging and the determined time when the battery is required to be charged.

That is, the system for recommending a charging station of an electric vehicle applied specific driving routes according to another embodiment of the present disclosure may compare the environmental information and the battery state information collected at each specific point with second environmental information measured in advance for a specific driving route and the second battery state information according to the second environmental information to generate the expected battery state information, thereby recommending the charging station with the shortest movement route.

In addition, when it is impossible to drive to a charging station of a specific driving route that has been previously recommended by analyzing the environmental information and the battery state information collected while driving on the specific driving route, another specific driving route may be re-searched, and the first expected battery state information may be generated based on third environmental information for the re-searched driving route and third battery state information analyzed according to the third environmental information, and the charging station with the shortest movement route on another specific driving route may be recommended.

The system for recommending a charging station of an electric vehicle applied specific driving routes according to an embodiment of the present disclosure provides the following effects.

The present disclosure has been devised to solve the above problems. According to the present disclosure, it is possible to compare the battery state information measured at the specific point on the first driving route with the battery state information measured in advance in various driving environments for the reference point corresponding to the specific point to predict the battery state information while driving on the driving routes and recommend the charging station according to the predicted battery state information.

According to the present disclosure, it is possible to compare the driving condition information, the weather information, and the traffic information measured at the specific point on the driving route changing according to the driving time with the plurality of pieces of driving condition information, the plurality of pieces of weather information, and the plurality of pieces of traffic information measured in advance for the reference point corresponding to the specific point, respectively, to extract one or more of the plurality of pieces of driving condition information, the plurality of pieces of weather information, and the plurality of pieces of traffic information measured in advance and predict the accurate battery state information.

According to the present disclosure, it is possible to change to another driving route based on the plurality of pieces of environmental information for another driving route included in the driving route database and the expected battery state information according to the plurality of pieces of environmental information, when it is predicted that the charging station recommendation is impossible for the driving route.

The spirit of the present disclosure has been just exemplified. It will be appreciated by those skilled in the art that various modifications and alterations can be made without departing from the essential characteristics of the present disclosure. Accordingly, the exemplary embodiments disclosed in the present disclosure are not to limit the present disclosure, but are to describe the spirit of the present disclosure. The scope of the present disclosure is not limited only to the exemplary embodiments.

Therefore, the scope of protection of the present disclosure should be interpreted by the claims below rather than being limited by the embodiments described above, and it should be interpreted that all spirits equivalent to the following claims fall within the scope of the present disclosure.

What is claimed is:

1. A system for recommending a charging station of an electric vehicle applied specific driving routes, the system comprising:
a vehicle driving information collection unit configured to generate a first vehicle driving information database including first battery state information and first environmental information at a specific point on a first driving route;
a database unit comprising a first vehicle driving information database, a second vehicle driving information database including a plurality of pieces of second environmental information measured in advance in various environments corresponding to a plurality of reference points on the first driving route and a plurality of pieces of second battery state information analyzed according to the plurality of pieces of second environmental information, a charging station database according to the first driving route, and a driving route database including the first driving route;
a battery state information prediction unit configured to compare the second vehicle driving information at a reference point matching the specific point among the plurality of reference points with the first vehicle driving information at the specific point to generate first expected battery state information; and
a charging station guide unit configured to determine whether the battery is required to be charged according to the first expected battery state information and analyze a charging station with a shortest movement route in the charging station database and transmit the analyzed result to a user terminal.

2. The system of claim 1, wherein the battery state information prediction unit is configured to:
compare the first environmental information measured at the specific point with the plurality of pieces of second environmental information measured in various environments on the reference point matching the specific point to extract the second environmental information matching the first environmental information, and
determine whether the first battery state information matches the second battery state information analyzed according to the second environmental information matching the first environmental information to correct the first battery state information according to the second battery state information.

3. The system of claim 2, wherein the first environmental information includes first driving state information, first weather information, and first traffic information, and
the plurality of pieces of second environmental information includes a plurality of pieces of second driving state information, a plurality of pieces of second weather information, and a plurality of pieces of second traffic information measured in advance in various environments according to the first driving route.

4. The system of claim 3, wherein the battery state information prediction unit is configured to:
compare the first driving state information, the first weather information, and the first traffic information measured at the specific point on the first driving route, respectively, with the plurality of pieces of second driving state information, the plurality of pieces of second weather information, and the plurality of pieces of second traffic information measured in advance at the reference point corresponding to the specific point to extract one or more of the plurality of pieces of second driving state information, the plurality of pieces of second weather information, and the plurality of pieces of second traffic information; and
evaluate the accuracy of the first battery state information.

5. The system of claim 3, wherein an interval of the specific points on the first driving route is adjusted according to one or more of the first battery state information, the first driving state information, the first weather information, and the first traffic information.

6. The system of claim 1, wherein, when it is predicted that it is impossible to recommend the charging station on the first driving route, the charging station guide unit is configured to change the first driving route to the second driving route based on the first battery state information, the first environmental information, a plurality of pieces of third environmental information according to the second driving route further included in the driving route database, and a plurality of pieces of third battery information according to the third environmental information.
